(19) United States
(12) Patent Application Publication
(10) Pub. No.: US 2024/0405601 A1
(43) Pub. Date: Dec. 5, 2024

(54) Support System and Support Method

(71) Applicant: HITACHI, LTD., Chiyoda-ku, Tokyo (JP)

(72) Inventors: Takashi TAKEMOTO, Tokyo (JP); Mamoru OKAMOTO, Tokyo (JP); Hiroshi UCHIGAITO, Tokyo (JP); Thantip Sirinabhigupta KRASIENAPIBAL, Tokyo (JP); Keisuke TERADA, Tokyo (JP)

(21) Appl. No.: 18/694,202

(22) PCT Filed: Sep. 22, 2021
(86) PCT No.: PCT/JP2021/034754

§ 371 Date: Mar. 21, 2024

(51) Int. Cl. H02J 13/00

(52) U.S. Cl. CPC H02J 13/00001; H02J 2203/20

(57) ABSTRACT

It is provided a support system for supporting management of a regional energy system, comprising an arithmetic device and a storage device, wherein the support system is configured to: receive, by the arithmetic device, power supply-demand information on nanogrid equipment and transport information relating to transport by the vehicle; perform, by the arithmetic device, simulation through use of the power supply-demand information and the transport information to calculate nanogrid operation information indicating a power status of the nanogrid equipment during a predetermined period and vehicle operation information indicating a running status and charging and discharging statuses of the vehicle; and generate, by the arithmetic device data for displaying both data organized in terms of power supply and demand for power in the nanogrid equipment and data in terms of transport by the vehicle on a single screen based on the nanogrid operation information and the vehicle operation information.

### BACKGROUND OF THE INVENTION

This invention relates to a system and a method for visualizing or simulating statuses of nanogrids and vehicles and supporting management of the nanogrids.

Microgrids and nanogrids are employed due to increases in renewable energy power generation for suppressing global warming, increases in energy supply that is resistant to disasters, and limitations on power transmission network capacity. In addition, there is known a technology in which a vehicle with an energy storage medium installed therein runs between a plurality of nanogrids to circulate energy, thereby reducing costs for energy storage and supply-and-demand adjustment, a power cost, and an amount of carbon dioxide to be generated.

Construction of a safe and secure living infrastructure and a stable, inexpensive, low-carbon, and decarbonized energy system in each region is required toward a with-COVID-19 society and a post-COVID-19 society. Meanwhile, renewable energy such as solar power generation has great fluctuations in supply amount. In addition, in a region in which demand sites and sites suitable for renewable energy are dispersed, a large amount of cost and a long construction period are required in order to increase the capacity of a power transmission line from a renewable power generation facility to a demand site, and coupling to a new renewable energy power system is difficult. In addition, in light of demand for construction of low-carbon, decarbonized, and self-sustaining energy systems that utilize a wide variety of renewable energy in neighboring regions and remote regions, it is important to construct new services that contribute to local industry and daily life in order to suppress burdens on costs involved in introduction of new energy systems.

The background art in this technical field includes the following related art. In JP 2021-67958 A, there is described an invention that provides an energy supply-and-demand system including: a time identification module that identifies an energy shortage forecast time of a target energy station based on a weather forecast for a region to which the target energy station belongs; a station identification module that identifies an energy station in which an energy surplus is predicted at the energy shortage forecast time based on a weather forecast for another region different from the region; and a station selection module that selects, from among energy stations identified by the station identification module, a supply energy station capable of supplying energy to the target energy station by transport of energy before the energy shortage forecast time.

### SUMMARY OF THE INVENTION

In a regional energy system in which a plurality of nanogrids are constructed and vehicles (for example, electric vehicles; hereinafter also referred to as “EVs”) that transport people and objects are used to transport energy to interchange power between the nanogrids, to thereby eliminate an energy shortage, values to be improved may arise in addition to power. In addition, in the regional energy system, it is required to determine an operation policy on EVs and power generation equipment in each small grid while taking into consideration uncertainties such as weather, demand for power, and transport demand.

However, in JP 2021-67958 A, visualization through simulation of statuses relating to power and values (such as responses to a disaster and improvement in transport efficiency) other than power is not taken into consideration. Specifically, related-art simulators optimize power and transport independently of each other, and thus cannot present optimum operation that takes both demand for power and transport demand into consideration at the same time.

Accordingly, there is demand for a simulator that visualizes power and transport management for presenting optimum operation policy for achieving target values (such as a profit, CO₂ reduction, and a self-sustaining period at a time of a disaster).

The representative one of inventions disclosed in this application is outlined as follows. There is provided a support system for supporting management of a regional energy system, the support system comprising: an arithmetic device configured to execute predetermined processing; and a storage device coupled to the arithmetic device, the support system is configured with a computer including the arithmetic device and the storage device, the regional energy system including: nanogrid equipment including at least one of a power generation device or an electricity storage device; and a vehicle in which a storage battery is installed, wherein the support system is configured to: receive, by the arithmetic device, power supply-demand information on the nanogrid equipment and transport information relating to transport by the vehicle; perform, by the arithmetic device, simulation through use of the power supply-demand information and the transport information to calculate nanogrid operation information indicating a power status of the nanogrid equipment during a predetermined period and vehicle operation information indicating a running status and charging and discharging statuses of the vehicle; and generate, by the arithmetic device data for displaying both data organized in terms of power supply and demand for power in the nanogrid equipment and data in terms of transport by the vehicle on a single screen based on the nanogrid operation information and the vehicle operation information.

According to the at least one aspect of this invention, it is possible to simultaneously visualize power operation and transport effects over the entire regional energy system formed of nanogrids and vehicles with respect to fluctuations in power supply and demand for power and transport demand. This allows a user of the support system to determine an operation policy on the regional energy system in consideration of two or more values including the power operation and the transport effects. Problems, configurations, and effects other than those described above are revealed in the following description of at least one embodiment of this invention.

### BRIEF DESCRIPTION OF THE DRAWINGS

FIG. 1 is a diagram for illustrating an outline of a regional energy system according to an embodiment of this invention.

FIG. 2 is a diagram for illustrating a physical configuration of an energy transport optimization support system according to the embodiment.

FIGS. 3A and 3B are flow charts of processing executed by the energy transport optimization support system according to the embodiment.

FIG. 4 is a diagram for illustrating an example of a data flow in the processing executed by the energy transport optimization support system according to the embodiment.

FIG. 5 is a diagram for illustrating an example of a nanogrid information display screen according to the embodiment.

FIG. 6 is a diagram for illustrating enlarged details of a grid power data display area according to the embodiment.

FIG. 7 is a diagram for illustrating enlarged details of a power generation data display area according to the embodiment.

FIG. 8 is a diagram for illustrating enlarged details of a transport data display area according to the embodiment.

FIG. 9 is a diagram for illustrating an example of a transport information display screen according to the embodiment.

FIG. 10 is a diagram for illustrating enlarged details of a power generation data display area according to the embodiment.

FIG. 11 is a diagram for illustrating enlarged details of a transport data display area according to the embodiment.

FIG. 12 is a diagram for illustrating an example of a disaster response information display screen according to the embodiment.

FIGS. 13A and 13B are diagrams for illustrating an example of data input and output for simulation by the energy transport optimization support system according to the embodiment.

### DESCRIPTION OF THE PREFERRED EMBODIMENTS

Now, an energy transport optimization support system that outputs information for appropriately managing power energy of a nanogrid and appropriately managing transport by a vehicle is described as an example of the support system according to this invention.

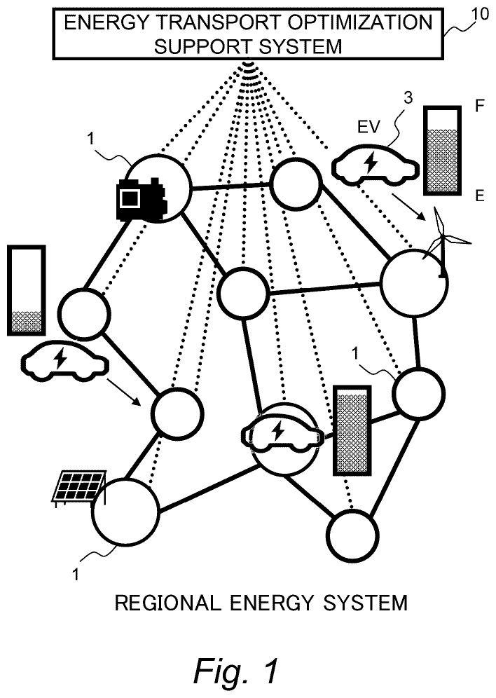

FIG. 1 is a diagram for illustrating an outline of a regional energy system including a plurality of nanogrids 1 managed by an energy transport optimization support system 10 according to at least one embodiment of this invention. In FIG. 1, the solid line represents a movement route of an electric vehicle 3, and the dotted line represents a communication path for transmitting information. The energy transport optimization support system 10 is coupled to the plurality of nanogrids 1 in a manner that allows communication therebetween.

The nanogrid 1 includes a power source that generates power, a load that consumes power, and a power control device (not shown) that controls a power generation amount and power consumption. The nanogrid 1 may include a storage battery that accumulates power, in order to fill a gap between power supply and demand for power. The power source is mainly a device that generates power from renewable energy, such as solar power, wind power, geothermal power, and a fuel generator capable of generating power from biomass fuel. Examples of the load include equipment that consumes power in the nanogrid 1, agricultural machinery, and transmitting power to public facilities such as a gymnasium, a community hall, and a school. The electric vehicle 3 running in the region also consumes power and serves as the load.

The power control device of the nanogrid 1 manages a power supply-demand state of the relevant nanogrid 1. The nanogrid 1 and the electric vehicle 3 are coupled to an energy management system (not shown). The energy management system receives, from the power control devices of the respective nanogrids 1, a plurality of pieces of order information for power, manages power trade based on the received pieces of order information, and sends instructions about charging, discharging, and movement to the electric vehicle 3. The energy management system also outputs a calculation result to a user. The power control device may only manage the power supply-demand state of the relevant nanogrid without managing the power trade between the plurality of nanogrids.

In a region including the nanogrid 1, at least one electric vehicle 3, which is a vehicle running on electricity, travels between the nanogrids 1 through use of charged power. The electric vehicle 3 may be a delivery truck, an on-demand bus, a taxi, or the like, which transports freight or people in the relevant region, or may transport freight or people between base locations (for example, places in which freight or people gather, such as a government office, a hospital, a station, a shopping district, and the like) other than the nanogrid 1. A battery for running that can be charged with electricity and discharge electricity is installed in the electric vehicle 3. In addition thereto, a battery for power transport that can be charged with electricity and discharge electricity is installed in the electric vehicle 3, and the electric vehicle 3 charges the battery in a predetermined nanogrid 1 in accordance with a result of the power trade, and discharges the battery in another nanogrid 1, to thereby adjust power supply and demand for power between the plurality of nanogrids 1. The battery for power transport and the battery for running may be one same battery or separate batteries. A battery capable of rapid charging is preferred as a battery installed in the electric vehicle 3, but a battery only capable of normal charging or a battery that can be replaced easily in a short time may be installed.

The electric vehicle 3 is preferred to be a type of electric motor vehicle that runs by driving a motor with charged electricity, but may be an engine vehicle that uses an internal combustion engine as a drive source, or a fuel cell vehicle that runs on power generated by a fuel cell. The nanogrid 1 provides power to be traded between the plurality of nanogrids 1 to the battery for power transport of the electric vehicle 3. In place of an electric vehicle, a hydrogen vehicle or the like equipped with a battery for power transport which can be charged with electricity and discharge electricity may be used.

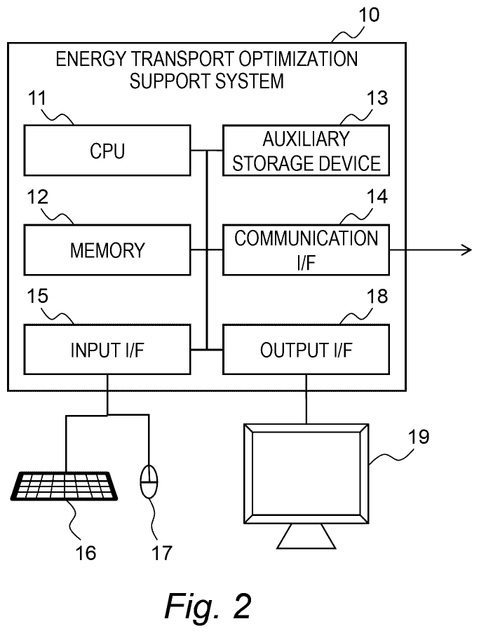

FIG. 2 is a diagram for illustrating a physical configuration of the energy transport optimization support system 10 according to the at least one embodiment.

The energy transport optimization support system 10 according to the at least one embodiment is configured from a computer including a processor (CPU) 11, a memory 12, an auxiliary storage device 13, and a communication interface 14.

The processor 11 executes a program stored in the memory 12. Part of processing executed by the processor 11 by running the program may be executed by another arithmetic device (for example, an arithmetic device built from hardware such as an FPGA or an ASIC).

The memory 12 includes a ROM, which is a non-volatile storage element, and a RAM, which is a volatile storage element. The ROM stores an unchanging program (for example, BIOS) among others. The RAM is a high-speed and volatile storage element such as a dynamic random access memory (DRAM), and temporarily stores a program executed by the processor 11 and data used in the execution of the program.

The auxiliary storage device 13 is, for example, a large-capacity and non-volatile storage device such as a magnetic storage device (an HDD) or a flash memory (an SSD), and stores a program executed by the processor 11 and data used in the execution of the program. Specifically, the program is read out of the auxiliary storage device 13, loaded onto the memory 12, and executed by the processor 11.

The communication interface 14 is a network interface device that controls communication to and from other devices (the power control devices in the nanogrids 1, the electric vehicle 3, and the like) by following a predetermined protocol.

The energy transport optimization support system 10 may include an input interface 15 and an output interface 18. The input interface 15 is an interface to which a keyboard 16 and a mouse 17 are coupled to receive input from a user. The output interface 18 is an interface to which a display device 19 and a printer (not shown) are coupled to output a result of executing a program in a format visually recognizable to the user. The input interface 15 and the output interface 18 may be provided by a terminal coupled to the energy transport optimization support system 10 via a network.

A program executed by the processor 11 is provided to the energy transport optimization support system 10 via a removable medium (a CD-ROM, a flash memory, or the like) or a network, and is stored in the non-volatile auxiliary storage device 13, which is a non-transitory storage medium. It is accordingly preferred for the energy transport optimization support system 10 to include an interface that reads data out of a removable medium.

The energy transport optimization support system 10 is a computer system configured on a single physical computer, or on a plurality of logically or physically configured computers, and may operate in a single thread or a plurality of threads on the same computer, or may operate on a virtual machine built on a plurality of physical computer resources. Component units of the energy transport optimization support system 10 may operate on different computers.

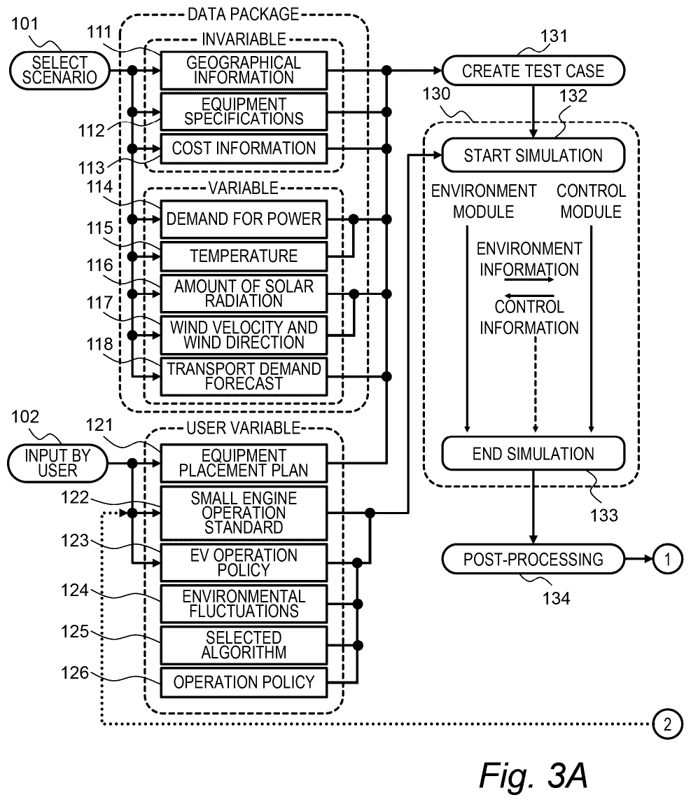

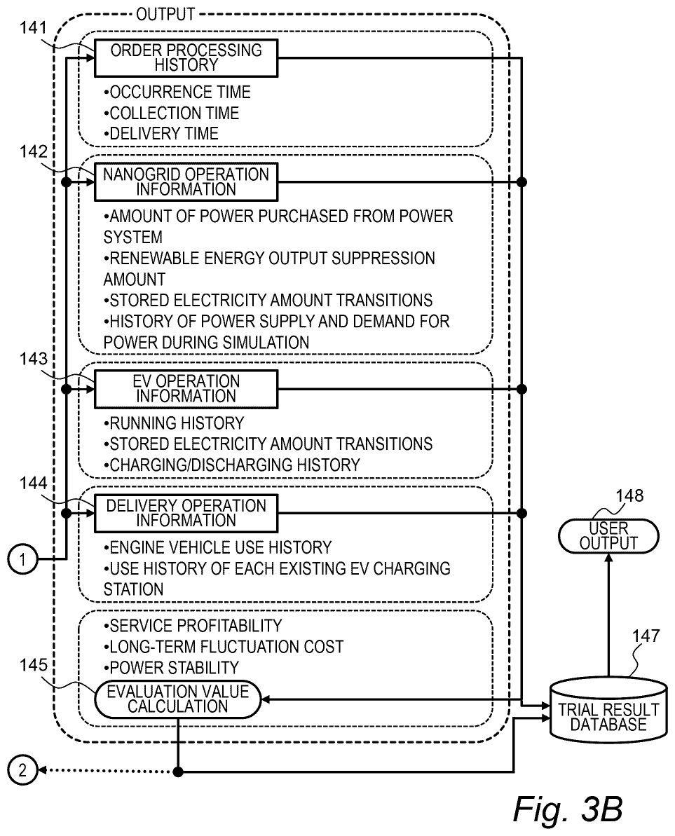

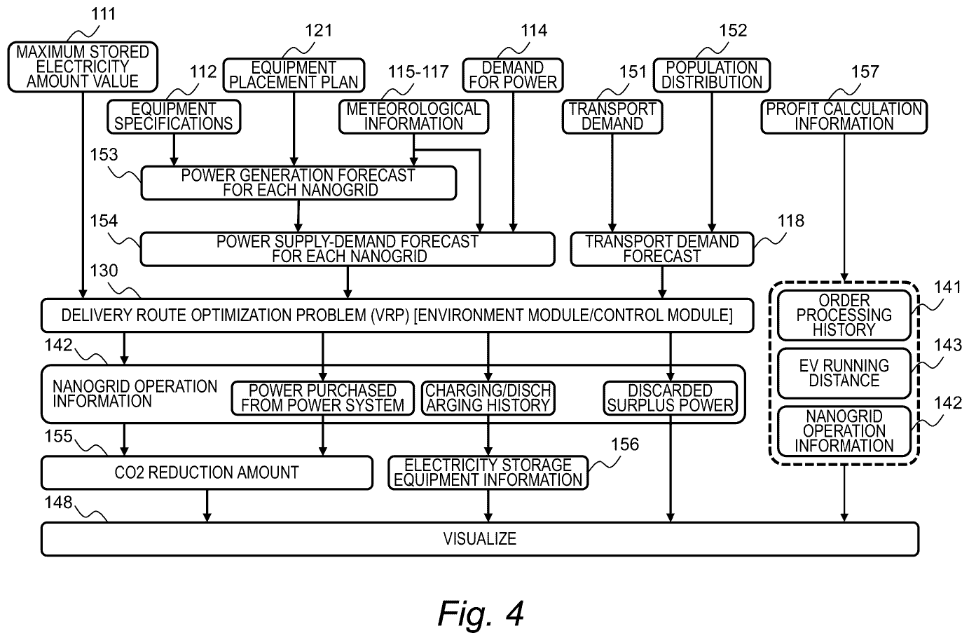

FIGS. 3A and 3B are flow charts of processing executed by the energy transport optimization support system 10 according to the at least one embodiment, and FIG. 4 is a diagram for illustrating an example of a data flow in the processing.

First, the user selects a scenario of simulation (101). The scenario is a parameter group for designating a region to be a target of simulation and meteorological conditions, and includes information such as geographical information, equipment specifications, cost information, demand for power, a temperature, an amount of solar radiation, wind velocity and wind direction, and a transport demand forecast. The scenario selected by the user is extracted into a data package, and a test case for simulation is created (131). In the data package, geographical information 111, equipment specifications 112, and cost information 113 are classified into invariable data that does not change during a simulation time period, and demand 114 for power, a temperature 115, an amount 116 of solar radiation, wind velocity and wind direction 117, and a transport demand forecast 118 are classified into variable data that changes during the simulation time period. The variable data may become invariable data when temporal changes of parameters are not taken into consideration.

The geographical information 111 is a map of a region to be a target of simulation, and is obtained by expressing positions of respective base locations (a nanogrid, a departure point and an arrival point of transport, and the like) and roads in the form of nodes and edges. The equipment specifications 112 are specifications representing performance of respective pieces of equipment (power generation equipment, a storage battery, a vehicle, and the like). The cost information 113 is initial costs required for installation of the respective pieces of equipment and running costs required for operation thereof. The demand 114 for power is a temporal change in demand for power during a simulation target time period, and past data on demand for power on a day involving, for example, similar social activity and meteorological conditions may be used. The temperature 115 is a change in temperature during the simulation target time period, and is a parameter for increasing or decreasing an amount of power for cooling and heating and calculating a power supply-demand forecast 154. The amount 116 of solar radiation is a change in amount of solar radiation during the simulation target time period, and is a parameter for calculating a power generation forecast 153 based on sunlight. The wind velocity and wind direction 117 are changes in wind during the simulation target time period, and are parameters for calculating a power generation forecast 153 based on wind power. The transport demand forecast 118 is demand for transport of people or cargo during the simulation target time period. The transport demand forecast 118 can be calculated from potential transport demand 151 and a population distribution 152. Regional characteristics, a human flow and a traffic flow due to an event, and meteorological conditions may be taken into consideration in the calculation of the transport demand forecast 118.

Further, the user inputs a user variable (102). The user variables include an equipment placement plan 121, a small engine operation standard 122, an EV operation policy 123, environmental fluctuations 124, a selected algorithm 125, and an operation policy 126. The energy transport optimization support system 10 may acquire a user variable from another system with which the energy transport optimization support system 10 cooperates. As the user variable, at least one of the environmental fluctuations 124, the selected algorithm 125, or the operation policy 126 may be acquired depending on an application of the simulation.

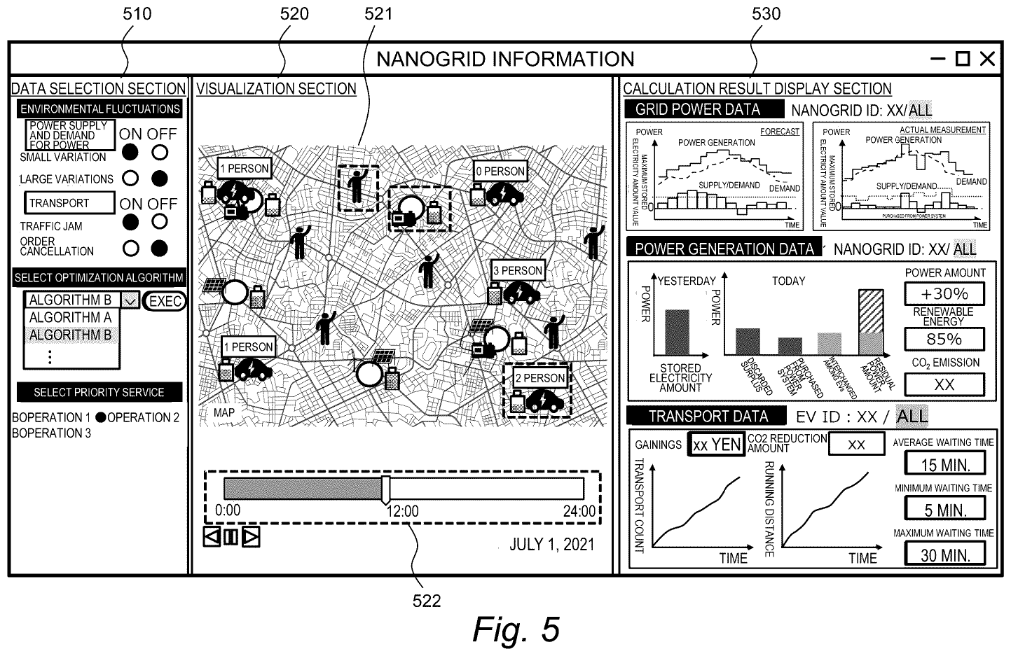

The equipment placement plan 121 is an equipment placement plan for the nanogrid 1. Examples thereof include types and the numbers of power generation devices and electricity storage devices to be arranged in the nanogrid 1 and a type and the number of EVs. The small engine operation standard 122 includes operation conditions (an operation time slot, an operation count, a storage battery the operation of which is to be started or stopped, a condition for demand for power, and the like) of the internal combustion engine to be placed in the nanogrid 1 and a type (for example, light oil, heavy oil, biomass fuel, gas associated with hot spring, or hydrogen) of fuel to be used. The EV operation policy 123 is an operation policy on the electric vehicle 3 that travels between the nanogrids 1, and includes allocation of applications (freight transport, human transport, electricity transport, standby, and the like) of the electric vehicle 3 and conditions for changing the allocation. The environmental fluctuations 124 are a degree of perturbation of conditions in the simulation, and is a degree of variation in power supply and demand for power and whether or not an inevitable event occurring in transport is to be taken into consideration in the simulation. The selected algorithm 125 is an algorithm to be used for the simulation. Characteristics of algorithms vary so that, for example, even under the same conditions, a waiting time in a transport service is short or power purchased from a power system in power operation is small, and hence it is recommended to select an algorithm corresponding to a purpose. The characteristics of the algorithms may be displayed on a screen. This can support the user in selecting an algorithm for the energy transport optimization support system 10. The operation policy 126 is an operation policy based on selection of a priority service. The environmental fluctuations 124, the selected algorithm 125, and the operation policy 126 are selectable in a data selection section 510 illustrated in FIG. 5.

The energy transport optimization support system 10 applies the created test case and the input user variables to the selected algorithm, and starts simulation (132). A simulator 130 calculates operation information for the nanogrid 1 and the electric vehicle 3 through optimization processing based on the user variables, and calculates an evaluation value corresponding to a target service. In a regional energy system in which the nanogrids 1 are coupled to each other through intermediation of the electric vehicle 3 or the like, it is possible to formulate a delivery route optimization problem (vehicle routing problem; hereinafter referred to as “VRP”) for transporting electricity, people, and objects, and to use a vehicle routing problem (VRP) solver for the optimization processing. Further, in a power system coupled by a transmission and distribution network, optimum power flow calculation can be used. The simulator 130 includes therein an environment module for calculating environment information and a control module for calculating control information, and searches for an optimum solution of the delivery route optimization problem while exchanging the environment information and the control information between the environment module and the control module. When the simulation is ended, the environment information and the control information are output (133), and in post-processing 134, results of the simulation are aggregated for each of the nanogrids 1 and each of the electric vehicles 3. Specifically, an order processing history 141, nanogrid operation information 142, EV operation information 143, and delivery operation information 144 are output from the post-processing 134. Now, an example in which simulation is executed based on the environmental fluctuations 124 and the operation policy 126 that are selected in the data selection section 510 is described. When the option “SMALL VARIATIONS” under “POWER SUPPLY AND DEMAND FOR POWER” of the environmental fluctuations 124 is turned on, the simulation may be executed by, for example, adding variations predicted from past demand data and meteorological data to the power supply and demand for power in a normal distribution. Meanwhile, when the option “LARGE VARIATIONS” under “POWER SUPPLY AND DEMAND FOR POWER” of the environmental fluctuations 124 is turned on, the simulation may be executed by formulating a probability at which large variations occur through use of a uniform distribution or a power law distribution. Possible examples of the large variations include fluctuations in power supply and demand for power due to sudden changes in weather such as localized downpour and, in a transport service, order cancellation and a failure of an electric vehicle. When “OPERATION 3” in which importance is placed on a power supply value is selected in the operation policy 126, the simulation may be executed by weighting an objective function with respect to the power supply value or by increasing the number of electric vehicles allocated for the power operation. Meanwhile, when “OPERATION 1” in which importance is placed on a transport value is selected in the operation policy 126, the simulation may be executed by weighting an objective function with respect to the transport value or by increasing the number of electric vehicles allocated for the transport.

The order processing history 141 is information on transport corresponding to a transport request, and includes an occurrence time, a collection time, and a delivery time for each transport. The order processing history 141 can be used to evaluate an equipment scale and profitability required to satisfy the transport demand, and can be used to compare profits with those of existing transport infrastructure.

The nanogrid operation information 142 is information on power generation, consumption, and input/output of power for each nanogrid 1, and includes an amount of power purchased from the power system, a renewable energy output suppression amount, stored electricity amount transitions, and a history of power supply and demand for power during simulation. When the nanogrid operation information 142 is used, operation efficiency of renewable energy and an appropriate equipment scale of each nanogrid (electricity storage equipment information 156) can be estimated, and a self-sustaining operation possible period for a case of being paralleled off from the power system in a disaster can be evaluated.

The EV operation information 143 is information relating to operation of the electric vehicle 3, and includes a running history, stored electricity amount transitions, and a charging/discharging history. When the EV operation information 143 is used, it is possible to estimate consumption of a vehicle body and a storage battery, and to perform trial calculation of a long-term cost.

The delivery operation information 144 is information relating to operations of the electric vehicle 3, the engine vehicle, the fuel cell vehicle, and the like, and includes an engine vehicle use history and a use history of each existing EV charging station. Through use of the delivery operation information 144, it is possible to perform trial calculation of an amount of reduction in environmental load (for example, a carbon dioxide reduction amount 155) caused by replacement of the engine vehicle by the electric vehicle 3.

The order processing history 141, the nanogrid operation information 142, the EV operation information 143, and the delivery operation information 144 output from the post-processing 134 are input to evaluation value calculation 145. Profit calculation information 157 includes information relating to running costs of the power generation equipment and the electric vehicle and information on transport fees in a transport service.

The evaluation value calculation 145 uses the order processing history 141, the nanogrid operation information 142, the EV operation information 143, and the delivery operation information 144 to calculate the evaluation value. Examples of the evaluation value include the power cost calculated from the amount of power purchased from the power system, a fuel consumption amount calculated from a running history of the engine vehicle, the carbon dioxide reduction amount 155 calculated from a running history of the electric vehicle 3, and the transport fee calculated from an order processing history, and serve as indices for evaluating service profitability, a long-term fluctuation cost, power stability, and the like. The calculated evaluation values are stored in a trial result database 147.

The trial result database 147 stores, in addition to the calculated evaluation values, the order processing history 141, the nanogrid operation information 142, the EV operation information 143, and the delivery operation information 144 that are output from the post-processing 134. The data stored in the trial result database 147 enables user output 148 for display in a time series of data including past data. The user output 148 can also output data aggregated as a data package in a predetermined format, user variables input for the simulation, calculated evaluation values, actual records and predictions of transport, and the like.

In this manner, the energy transport optimization support system 10 according to the at least one embodiment can visualize and display data evaluable from various viewpoints. Specific examples of information visualized from the various user perspectives relating to the power management system according to the at least one embodiment of this invention are described below.

FIG. 5 is a diagram for illustrating an example of a nanogrid information display screen.

The nanogrid information display screen can display information on the nanogrids in results of simulation under input conditions and past actual records, and displays aggregated information suitable for an operator of the energy transport optimization support system 10. The nanogrid information display screen includes the data selection section 510, a visualization section 520, and a calculation result display section 530.

The data selection section 510 is an area that allows input of selection of each of the environmental fluctuations 124, the selected algorithm 125, and the operation policy 126 that are user variables in the simulation. It is only required to be able to set at least one of the environmental fluctuations 124, the selected algorithm 125, or the operation policy 126 depending on the application of the simulation.

The visualization section 520 is an area in which information relating to the operation of each EV, the stored electricity amount of the nanogrids, and the like is visualized and displayed. A map 521 in the visualization section 520 is displayed by being superimposed by icons each having a shape of a person and representing a position of a transport request, icons representing a position, equipment (such as power generation equipment and electricity storage equipment), and a stored electricity amount of each nanogrid 1, and icons representing a position, a stored electricity amount, and the number of passengers of each electric vehicle 3. The icon of each person requesting transport and the icon of each electric vehicle appear, disappear, and move with a lapse of time. The stored electricity amount of each nanogrid 1 and the stored electricity amount and the number of passengers of each electric vehicle 3 change with a lapse of time. Icons representing a position, a fuel loading amount, a stored electricity amount, and the number of passengers of each engine vehicle and icons representing a position of each EV charging station and the number of vehicles using this EV charging station may be displayed superimposed on the map 521. The visualization section 520 is provided with a time bar 522 that indicates a time of data currently being displayed. When a slider of the time bar 522 is moved, the positions of the electric vehicles 3 change and persons requesting transport appear and disappear in the map 521. The visualization section 520 is also provided with an input field for a date the data on which is to be displayed and buttons for playback, stop, and reverse playback. Movements of the electric vehicles 3 and people on a specified day can be visualized with a lapse of time through operation of the play button or the reverse play button, and states of the electric vehicles 3 and people at a freely-selected time can be visualized through operation of the stop button.

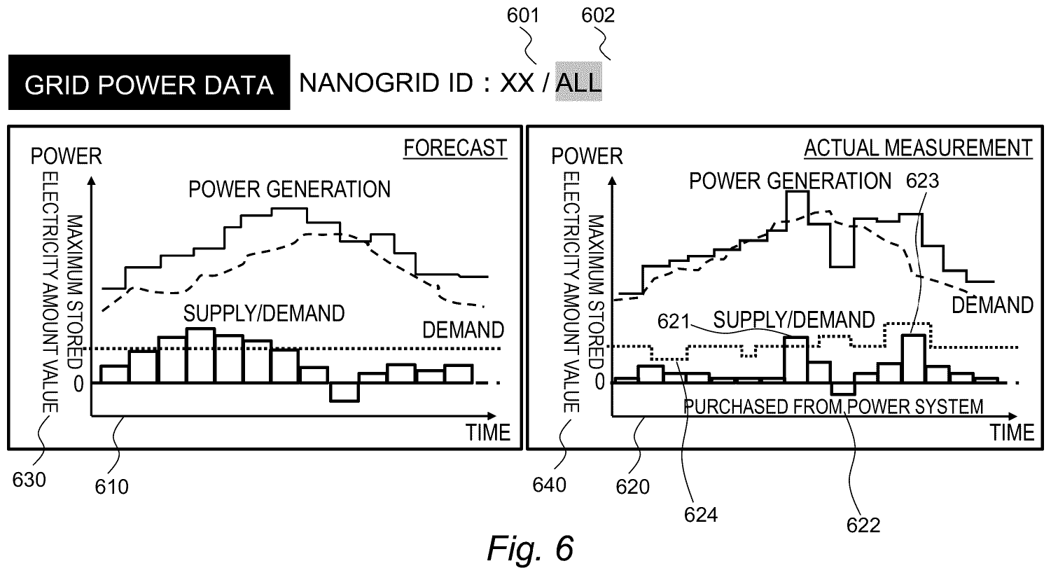

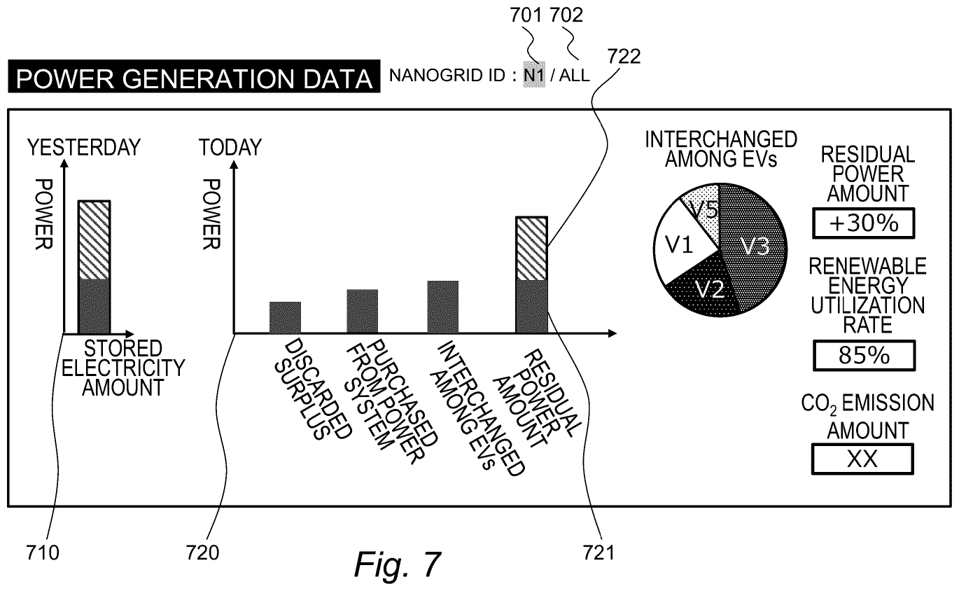

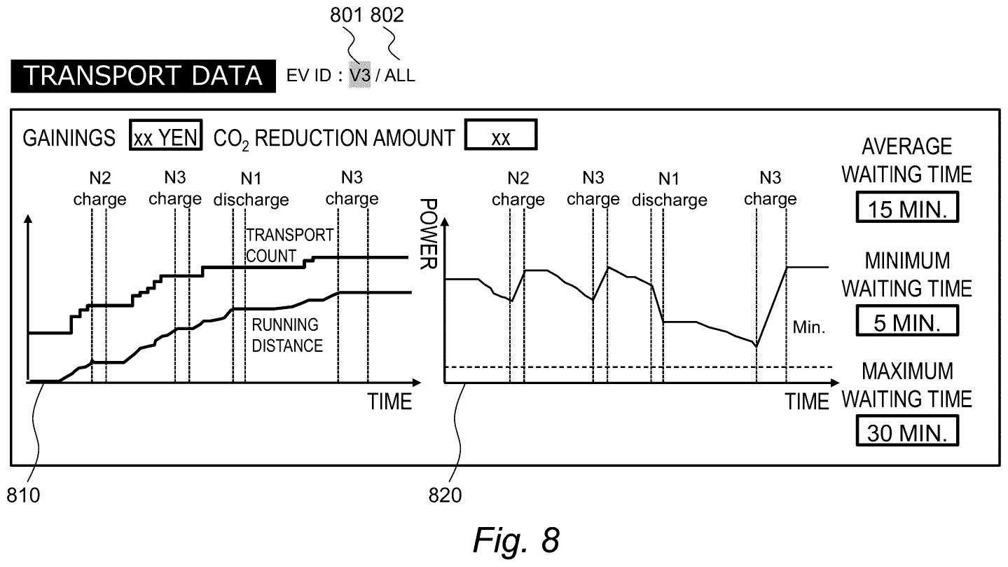

The calculation result display section 530 includes a grid power data display area, a power generation data display area, and a transport data display area. The grid power data display area displays predicted values and actual result values of a power generation amount, demand for power, and supply and demand (power supply margin=charged/discharged amount of the storage battery) of the nanogrid 1 in a graph format having a horizontal axis representing an elapsed time. Details of the grid power data display area are illustrated in FIG. 6. The power generation data display area displays power data on each nanogrid 1. Details of the power generation data display area are illustrated in FIG. 7. The transport data display area displays actual result values of the number of transports and a running distance of each electric vehicle 3 in the graph format having a horizontal axis representing an elapsed time. Details of the transport data display area are illustrated in FIG. 8.

FIG. 6 is a diagram for illustrating the enlarged details of the grid power data display area. Although the representation of the grid power data display area illustrated in FIG. 6 slightly differs from the representation of the grid power data display area illustrated in FIG. 5, both representation methods are acceptable.

The grid power data display area includes a predicted value display area 610 and an actual result value display area 620, and displays the predicted values and the actual result values of the power generation amount, the demand for power, and the supply and demand (power supply margin=charged/discharged amount of the storage battery) in the graph format having a horizontal axis representing an elapsed time. In the grid power data display area, the power generation amount, the demand for power, and the supply and demand can be displayed through switching between those of each nanogrid 1 designated in a nanogrid ID input field 601 and those of all the nanogrids 1 based on an all-nanogrid selection field 602. Actual result values of a power supply-demand gap are preferred to be displayed in a manner that allows distinction of an amount of power derived from the electric vehicle 3. The graphs of the power generation amount, the demand for power, and the supply and demand may be displayed through use of an existing display technology. In the predicted value display area 610, a maximum stored electricity amount value 630 is a value indicating a maximum electricity storage capacity of the electricity storage equipment permanently installed in the nanogrid 1. In the area “FORECAST,” the maximum stored electricity amount values basically exhibit a straight line due to no consideration of a running status of the electric vehicle 3. Through examination of the predicted value display area 610, a time slot in which power is likely to become surplus or a time slot in which power is likely to become insufficient can be identified from the predicted values of the power generation amount, the demand for power, and the supply and demand, and a running policy or the like of the electric vehicle 3 can thus be investigated.

In the actual result value display area 620, a maximum stored electricity amount value 640 is a value indicating a sum of maximum electricity storage capacities of the electricity storage equipment permanently installed in the nanogrid 1 and the storage battery provided to the electric vehicle 3 that is stopped in the nanogrid 1. For example, as a result of the simulation, it is indicated that, at a time 624 at which the electric vehicle 3 included in the nanogrid 1 is away from the nanogrid 1, the maximum stored electricity amount value 640 is temporarily reduced, while at a time 623 in which a plurality of electric vehicles 3 are stopped in the nanogrid 1, the maximum stored electricity amount value 640 is temporarily increased. The electric vehicle 3 can stop in the nanogrid 1, and can transfer power thereto and therefrom under control of the power control device of the nanogrid 1. A portion 621 at which the supply and demand exceed the maximum stored electricity amount value indicates that there is much surplus power and power that exceeds the maximum stored electricity amount of the electricity storage equipment of the nanogrid 1 and the storage battery of the electric vehicle 3 is discarded. A portion 622 in which the supply and demand are smaller than 0 indicates power purchased from the power system or power that has been discharged from the electric vehicle 3. The screen is desired to display distinctively whether power was purchased from the power system or discharged from the electric vehicle 3. The example of FIG. 6 indicates that power was purchased from the power system. In a case of discharge from the electric vehicle 3, it is preferred to simultaneously indicate an EV ID of the electric vehicle 3. Under a state in which the maximum stored electricity amount value 640 is large, surplus power is not discarded even when surplus power is large. In this manner, in the actual result value display area 620, the maximum stored electricity amount value 640 is displayed in accordance with time, and hence it is possible to explicitly examine what kind of contribution the electric vehicle 3 makes to the nanogrid 1. For example, in the time 623, the demand exceeds the maximum electricity storage capacity of the electricity storage equipment permanently installed in the nanogrid 1, but it is indicated that power that is originally supposed to have been discarded as surplus can be effectively utilized as a result of the stoppage of the electric vehicle 3.

FIG. 7 is a diagram for illustrating the enlarged details of the power generation data display area.

The power generation data display area displays data of power supplied to the nanogrid 1, and includes a previous-day data display area 710 (in FIG. 7, the previous day is indicated as “yesterday”; the same applies to other drawings) and a current-day data display area 720 (in FIG. 7, the current day is indicated as “today”; the same applies to other drawings). The previous-day data display area 710 displays, in a graph format, a stored electricity amount on a day previous to a simulation target day (a stored electricity amount usable on a current day that is the simulation target day). The current-day data display area 720 displays, in a graph format, an amount of power that is surplus and discarded on the current day, an amount of power purchased from the power system on the current day, an amount of power interchanged from another nanogrid 1 by the electric vehicle 3 on the current day, and a stored electricity amount on the current day (a stored electricity amount usable on the next day). It is preferred to display the stored electricity amount in a manner that allows an amount 722 of power derived from the electric vehicle 3 to be distinguished from another amount 721 of power. When the amount of power derived from the electric vehicle 3 is distinguished and visualized in this manner, it is possible to confirm a degree of contribution of the electric vehicle to the entire regional energy or the relevant nanogrid. In the power generation data display area, power data can be displayed through switching between that on each nanogrid 1 designated in a nanogrid ID input field 701 and that on all the nanogrids 1 based on an all-nanogrid selection field 702. The power generation data display area also displays a residual power amount that is an increase/decrease ratio of the stored electricity amount from the previous day, a renewable energy utilization rate obtained by dividing the power consumption amount derived from renewable energy by a total power consumption amount, and a carbon dioxide emission amount.

FIG. 8 is a diagram for illustrating the enlarged details of the transport data display area.

The transport data display area includes a transport count display area 810 and a power data display area 820. The transport count display area 810 displays actual result values of a transport count and a running distance in the graph format having a horizontal axis representing an elapsed time. The transport count is the number of transported persons, the number of transported pieces of freight, a weight of the transported freight, or the like. The transport count may be expressed not only as a number but also as a transport amount including an element of a distance, such as passenger-kilometers or ton-kilometers. The running distance is a distance traveled by the electric vehicle 3. The power data display area 820 displays a stored electricity amount of the electric vehicle 3 in the graph format having a horizontal axis representing an elapsed time. In the transport data display area, transport data can be displayed through switching between that on each electric vehicle 3 designated in an EV ID input field 801 and that on all the electric vehicles 3 based on an all-EV selection field 802. The transport data display area also displays gainings from transport and a carbon dioxide reduction amount of the electric vehicle 3 compared to an engine vehicle. The transport data display area further displays an average waiting time, a minimum waiting time, and a maximum waiting time of each electric vehicle 3. In the transport count display area 810 and the power data display area 820, information on the charging and discharging of a target electric vehicle 3 with respect to the nanogrid 1 is displayed. For example, “N2 charge” indicates that a storage battery installed in an electric vehicle was charged in the nanogrid 1 having a nanogrid ID of N2. Meanwhile, “N1 discharge” indicates that, in the nanogrid 1 having a nanogrid ID of N1, power is discharged from the storage battery installed in the electric vehicle to a storage battery or a load in the nanogrid 1. In this manner, information relating to the transfer of power to and from the nanogrid 1 by the electric vehicle 3 is displayed along with the data on the transport of people and objects by the electric vehicle 3, and hence it is possible to grasp how much influence is to be exerted on the power of the nanogrid through the transport by the electric vehicle 3.

On the nanogrid information display screen, the transport data on freight, people, and power is visualized together with the data on the charging and discharging of respective nanogrids, and hence relationships between the nanogrids and transport by each electric vehicle 3 are simultaneously understood, thereby allowing the user to easily determine the operation policy on the electric vehicle 3. In addition, the self-consumption rate, discarded power, and power purchased from the power system in each nanogrid 1 and the actual records of transport of each electric vehicle 3 are visualized, and hence it is possible to improve the utilization rate of renewable power and the gainings from transport by reviewing operation plans, the number of pieces of power generation equipment, and the number of electric vehicles 3.

Further, charged and discharged amounts of the storage battery performed in each nanogrid 1 and charging and discharging times thereof are known from the charging/discharging history, and can be used as references for equipment planning.

Further, it is possible to evaluate robustness against environmental fluctuations by switching uncertainties in power supply and demand for power and transport statuses. Balance between power generation and transport can be visualized through the switching of the priority service, and can be reflected in the operation policy.

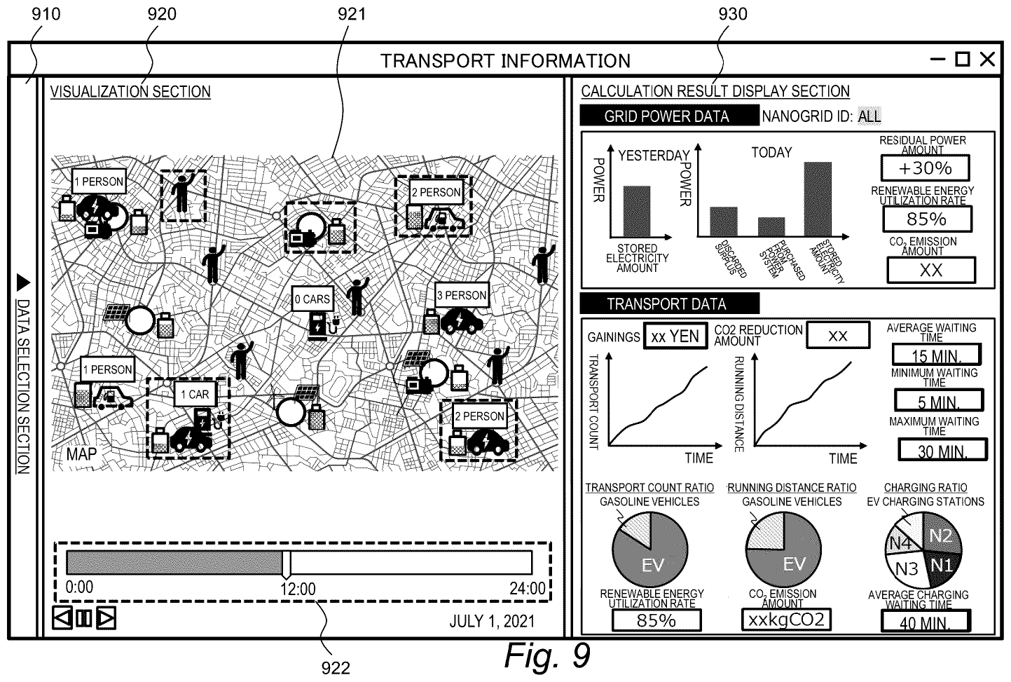

FIG. 9 is a diagram for illustrating an example of a transport information display screen.

The transport information display screen can display results of simulation under input conditions and past actual record data, and displays aggregated information suitable for a business operator providing the running of the electric vehicle 3. The transport information display screen includes a data selection section 910, a visualization section 920, and a calculation result display section 930.

The data selection section 910 is, as in the data selection section 510 of the nanogrid information display screen illustrated in FIG. 5, an area that allows input of selection of each of the environmental fluctuations 124, the selected algorithm 125, and the operation policy 126 that are user variables in the simulation. In FIG. 9, the data selection section 910 is presented in a folded state, and can be expanded into the state illustrated in FIG. 5 through operation of the triangular icon in the data selection section 910.

The visualization section 920 is an area in which information relating to the operation of each EV is visualized and displayed. On a map 921 in the visualization section 920, icons each having a shape of a person and representing a position of a transport request, icons representing a position, equipment (such as power generation equipment and electricity storage equipment), and a stored electricity amount of each nanogrid 1, icons representing a position, a stored electricity amount, and the number of passengers of each electric vehicle 3, icons representing a position, a fuel loading amount, a stored electricity amount, and the number of passengers of each engine vehicle, and icons representing a position of each EV charging station and the number of vehicles using this EV charging station are displayed. The icon of each person requesting transport and the icon of each electric vehicle appear, disappear, and move with a lapse of time. The stored electricity amount of each nanogrid 1 and the stored electricity amount and the number of passengers of each electric vehicle 3 change with a lapse of time. The visualization section 920 is provided with a time bar 922 that indicates a time of data currently being displayed. When a slider of the time bar 922 is moved, the positions of the electric vehicles 3 change and persons requesting transport appear and disappear in the map 921. The visualization section 920 is also provided with an input field for a date the data on which is to be displayed and buttons for playback, stop, and reverse playback. Movements of the electric vehicles 3 and people on a specified day can be visualized with a lapse of time through operation of the play button or the reverse play button, and states of the electric vehicles 3 and people at a freely-selected time can be visualized through operation of the stop button.

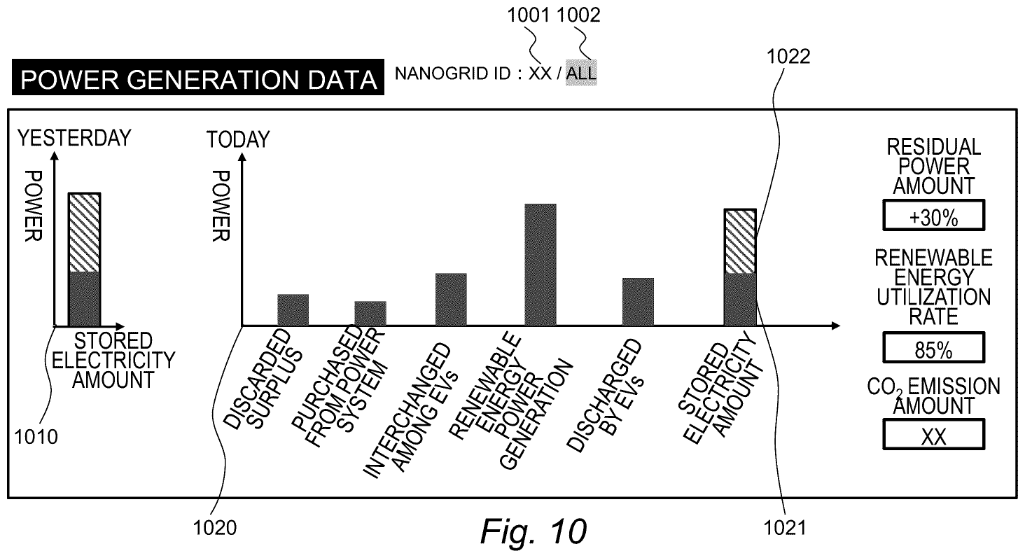

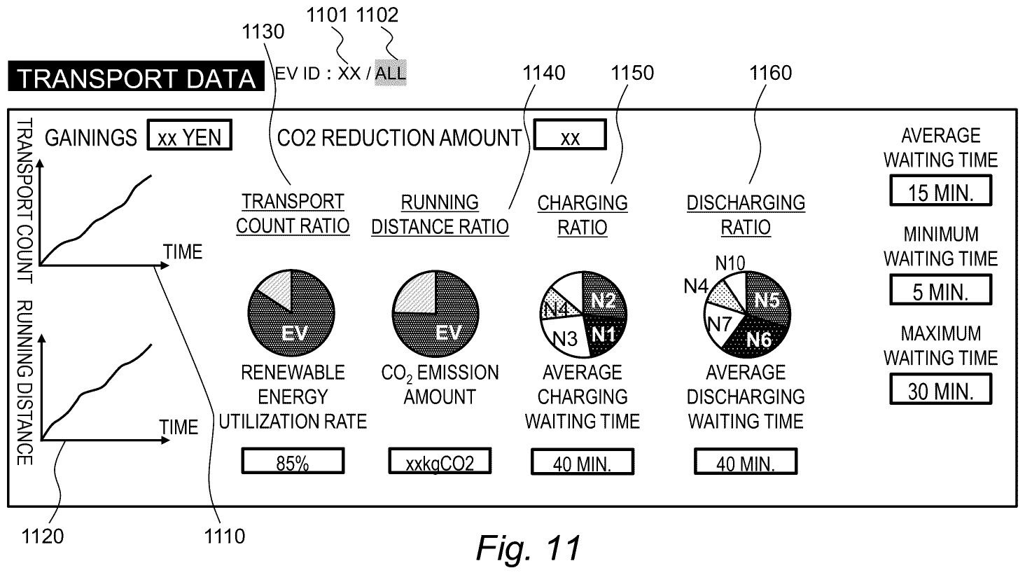

The calculation result display section 930 includes a power generation data display area and a transport data display area. The power generation data display area displays power data on each nanogrid 1. Details of the power generation data display area are illustrated in FIG. 10. The transport data display area displays actual result values of the number of transports and a running distance of each electric vehicle 3 in the graph format having a horizontal axis representing an elapsed time. Details of the transport data display area are illustrated in FIG. 11.

FIG. 10 is a diagram for illustrating the enlarged details of the power generation data display area.

The power generation data display area includes a previous-day data display area 1010 and a current-day data display area 1020. The previous-day data display area 1010 displays, in a graph format, a stored electricity amount on a day previous to a simulation target day (a stored electricity amount usable on a current day that is the simulation target day). The current-day data display area 1020 displays, in a graph format, an amount of power that is surplus and discarded on the current day, an amount of power purchased from the power system on the current day, an amount of power interchanged from another nanogrid 1 by the electric vehicle 3 on the current day, a power generation amount of renewable energy, a discharged amount of the electric vehicle 3, and a stored electricity amount on the current day (a stored electricity amount usable on the next day). It is preferred to display the stored electricity amount in a manner that allows an amount 1022 of power derived from the electric vehicle 3 to be distinguished from another amount 1021 of power. In the power generation data display area, power data can be displayed through switching between that on each nanogrid 1 designated in a nanogrid ID input field 1001 and that on all the nanogrids 1 based on an all-nanogrid selection field 1002. The power generation data display area also displays a residual power amount that is an increase/decrease ratio of the stored electricity amount from the previous day, a renewable energy utilization rate obtained by dividing the power consumption amount derived from renewable energy by a total power consumption amount, and a carbon dioxide emission amount.

FIG. 11 is a diagram for illustrating the enlarged details of the transport data display area.

The transport data display area includes a transport count display area 1110, a running distance display area 1120, a transport count ratio display area 1130, a running distance ratio display area 1140, a charging ratio display area 1150, and a discharging ratio display area 1160. The transport count display area 1110 displays the actual result value of the transport count in the graph format having a horizontal axis representing an elapsed time. The transport count is the number of transported persons, the number of transported pieces of freight, the weight of the transported freight, or the like. The transport count may be expressed not only as a number but also as a transport amount including an element of a distance, such as passenger-kilometers or ton-kilometers. The running distance display area 1120 displays the actual result value of the running distance in the graph format having a horizontal axis representing an elapsed time. The transport count ratio display area 1130 displays a ratio of the transport count by each electric vehicle 3 out of a total transport count. The running distance ratio display area 1140 displays a ratio of the running distance of each electric vehicle 3 out of a total running distance. The charging ratio display area 1150 displays a ratio among power supply devices used for charging the storage battery installed in each electric vehicle 3. In a case of charging from the storage battery installed in each nanogrid 1, the nanogrid ID of this nanogrid may be displayed, and a proportion of an EV charging station may be displayed in a different manner. The discharging ratio display area 1160 displays a ratio among pieces of equipment to which power was discharged in a case of discharging power from the storage battery installed in each electric vehicle 3 to another storage battery or a load. In a case of discharging power to a storage battery or a load installed in each nanogrid 1, the nanogrid ID of this nanogrid may be displayed. In the transport data display area, transport data can be displayed through switching between that on each electric vehicle 3 designated in an EV ID input field 1101 and that on all the electric vehicles 3 based on an all-EV selection field 1102. The transport data display area also displays gainings from transport, a carbon dioxide reduction amount compared to the engine vehicle, the renewable energy utilization rate, the carbon dioxide emission amount, an average charging waiting time that is an average value of times required to charge each electric vehicle 3, and an average discharging waiting time that is an average value of times required to discharge each electric vehicle 3 in the nanogrid 1. The transport data display area further displays the average waiting time, the minimum waiting time, and the maximum waiting time of each electric vehicle 3.

On the transport information display screen, the transport count and the running distance are visualized for the transport of freight, people, and power, and hence transport data (such as the carbon dioxide reduction amount in a transport service) indicating an environmental value can be displayed in an easy-to-understand manner. In addition, in the power generation data, the charged and discharged amounts between the nanogrid and the electric vehicle 3 can be visualized, and an influence exerted on the nanogrid through the running of the electric vehicle 3 can be visualized. A business operator providing the running of the electric vehicle 3 can achieve both economical efficiency and decarbonization by reviewing the profitability of a transport service and the number of vehicles therefor, and can contribute to achievement of an environmental objective.

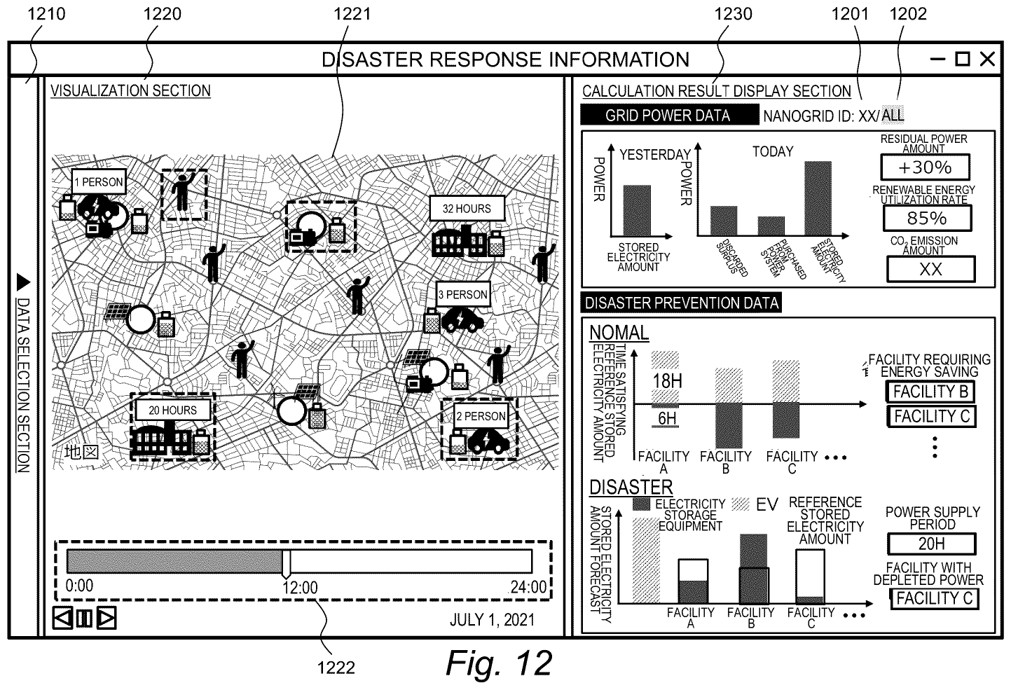

FIG. 12 is a diagram for illustrating an example of a disaster response information display screen.

The disaster response information display screen can display results of simulation under input conditions and past actual record data, and displays aggregated information relating to robustness against life of local residents. The disaster response information display screen includes a data selection section 1210, a visualization section 1220, and a calculation result display section 1230.

The data selection section 1210 is, as in the data selection section 510 of the nanogrid information display screen illustrated in FIG. 5, an area that allows input of selection of each of the environmental fluctuations 124, the selected algorithm 125, and the operation policy 126 that are user variables in the simulation. In FIG. 12, the data selection section 1210 is presented in a folded state, and can be expanded into the state illustrated in FIG. 5 through operation of the triangular icon in the data selection section 1210.

The visualization section 1220 is an area in which information relating to the operation of each EV is visualized and displayed. A map 1221 in the visualization section 1220 is displayed by being superimposed by icons each having a shape of a person and representing the position of a transport request, icons representing the position, the equipment (such as power generation equipment and electricity storage equipment), and the stored electricity amount of each nanogrid 1, icons representing a position, a stored electricity amount, and the number of passengers of each electric vehicle 3, and icons relating to each important facility (such as an evacuation center, a hospital, or a government office) and representing a position, a stored electricity amount, and a time (a reference stored electricity amount) during which power can be supplied to the expected number of persons to be accommodated. A storage battery is provided in an important facility, and is normally charged to a certain extent from an electric power system or the nanogrid 1 in order to be used at the time of a disaster. This storage battery is also used on a daily basis, and power is supplied from the storage battery when power supply from the nanogrid 1 becomes insufficient. The number of users and a maximum capacity of each important facility (evacuation center) may also be displayed. The icon of each person requesting transport and the icon of each electric vehicle appear, disappear, and move with a lapse of time. The stored electricity amount of each nanogrid 1 and the stored electricity amount and the number of passengers of each electric vehicle 3 change with a lapse of time. The visualization section 1220 is provided with a time bar 1222 that indicates a time of data currently being displayed. When a slider of the time bar 1222 is moved, the positions of the electric vehicles 3 change and persons requesting transport appear and disappear in the map 1221. The visualization section 1220 is also provided with an input field for a date the data on which is to be displayed and buttons for playback, stop, and reverse playback. Movements of the electric vehicles 3 and people on a specified day can be visualized with a lapse of time through operation of the play button or the reverse play button, and states of the electric vehicles 3 and people at a freely-selected time can be visualized through operation of the stop button.

The calculation result display section 1230 includes a power generation data display area and a disaster prevention data display area. The power generation data display area displays power data on each nanogrid 1. Specifically, the power generation data display area displays, in a graph format, a stored electricity amount on a day previous to a simulation target day (a stored electricity amount usable on a current day that is the simulation target day). The power generation data display area further displays, in a graph format, an amount of power that is surplus and discarded on the current day, an amount of power purchased from the power system on the current day, and a stored electricity amount on the current day (a stored electricity amount usable on the next day). It is preferred to display the stored electricity amount in a manner that allows an amount of power derived from the electric vehicle 3 to be distinguished from another amount of power. In the power generation data display area, power data can be displayed through switching between that on each nanogrid 1 designated in a nanogrid ID input field 1201 and that on all the nanogrids 1 based on an all-nanogrid selection field 1202. The power generation data display area also displays a residual power amount that is an increase/decrease ratio of the stored electricity amount from the previous day, a renewable energy utilization rate obtained by dividing the power consumption amount derived from renewable energy by a total power consumption amount, and a carbon dioxide emission amount.

The disaster prevention data display area displays states of important facilities in normal time and at the time of a disaster. A normal state display area displays, for each important facility, a time slot in which the stored electricity amount of the storage battery of the important facility satisfies the reference stored electricity amount and a time slot in which the reference stored electricity amount is not satisfied. In addition, it is preferred to extract and display an important facility of which the time slot in which the stored electricity amount of the storage battery does not satisfy the reference stored electricity amount is longer than a predetermined threshold value. A time-of-disaster state display area displays, for each important facility, the capacity of the storage battery of the important facility in comparison with the reference stored electricity amount. The stored electricity amount of the electric vehicle 3 is displayed as well. The electric vehicle 3 can move to a facility having a power shortage and supply power thereto. At this time, it is preferred to subtract the amount of power consumed by movement of the electric vehicle 3 (for example, an average of the amounts of power consumed by movement to the nanogrid 1) from the stored electricity amount. In addition, it is preferred to extract an important facility having a power shortage and display a name of the important facility and a power suppliable time.

The visualization of the total stored electricity amounts of the nanogrids 1 and the electric vehicles 3 allows appropriate power allocation plans to be formulated so that power supply to important facilities may not be interrupted at a time of an emergency such as at a time of a natural disaster. For example, it is preferred to determine a facility to be subjected to power distribution by the electric vehicle 3 in accordance with the stored electricity amount and the position of the electric vehicle 3, and output an instruction to distribute power by the electric vehicle 3. In addition, it is preferred to create a plan in which the electric vehicle 3 is to transport a resident who desires to move to an evacuation center and to transport power as well. Further, a person may be transported to a place in which power is supplied. It is also possible to formulate an enhancement plan for electricity storage equipment so as to satisfy a period during which an important facility maintains a self-sustainable state at the time of a disaster.

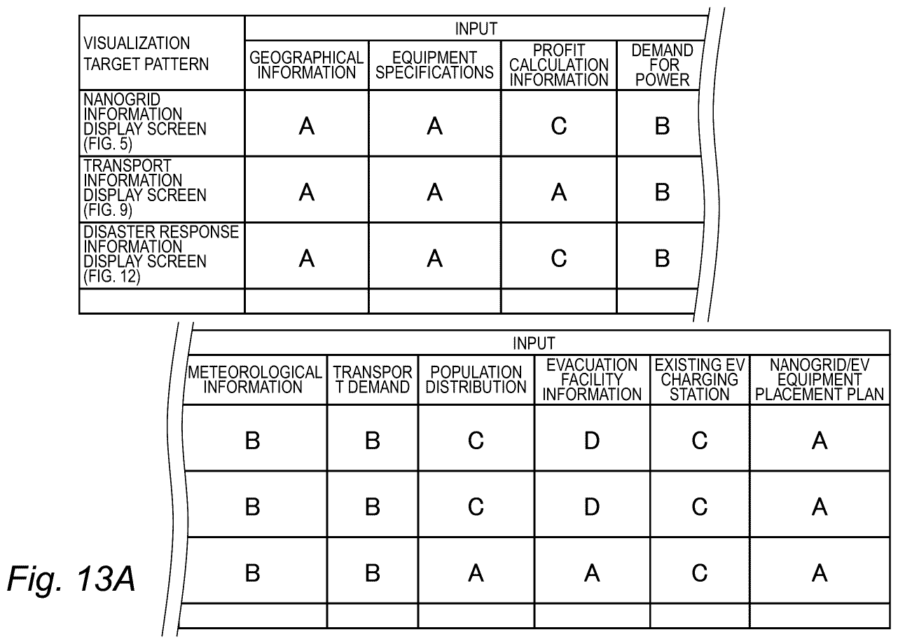

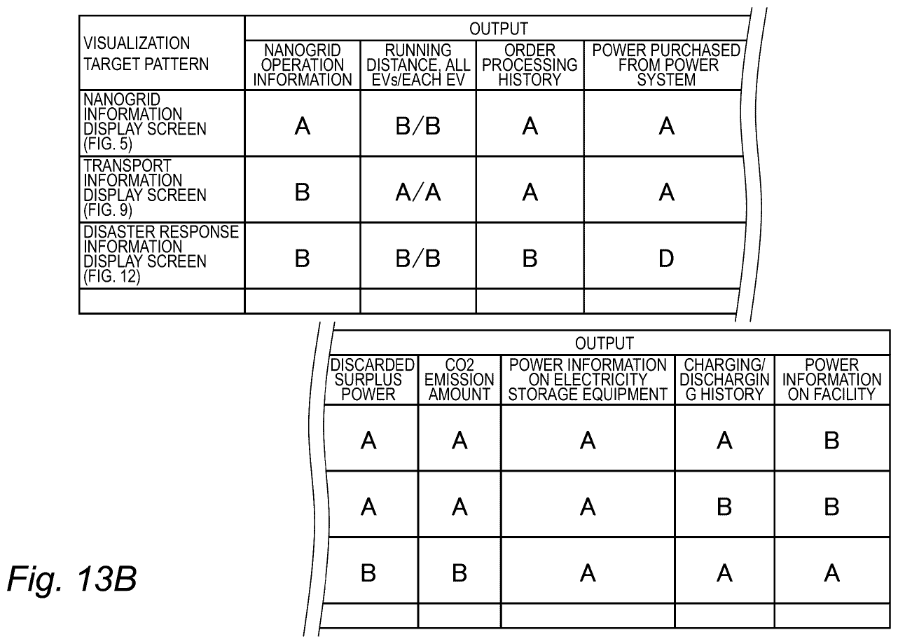

FIGS. 13A and 13B are diagrams for illustrating an example of data input and output for simulation by the energy transport optimization support system 10.

Input data required for simulation varies depending on the nanogrid information display screen described above with reference to FIG. 5, the transport information display screen described above with reference to FIG. 9, and the disaster response information display screen described above with reference to FIG. 12. In the input data, “A” represents essential data, “B” represents data usable for accurately grasping a state, and “D” represents unrequired data. Further, data to be output on the above-mentioned screens is as illustrated in FIG. 5, FIG. 9, and FIG. 12, and, when summarized, “A” represents a priority item that is key data for grasping a state, “B” represents an auxiliary item that is data useful for more reliably grasping a state, and “D” represents unrequired data.

As described above, the energy transport optimization support system 10 according to the at least one embodiment receives power supply-demand information on the nanogrid 1 and transport information relating to transport by the vehicle (electric vehicle 3), performs simulation through use of the power supply-demand information and the transport information to calculate nanogrid operation information indicating a power status of the nanogrid 1 during a predetermined period and vehicle operation information indicating a running status and charging and discharging statuses of the electric vehicle 3, and generates, based on the nanogrid operation information and the vehicle operation information, data for displaying, on a single screen, both data organized in terms of power supply and demand for power in the nanogrid 1 and data in terms of transport by the electric vehicle 3. Accordingly, the self-consumption rate, discarded power, and power purchased from the power system in each of the plurality of nanogrids 1 and the actual records of transport of each electric vehicle 3 are evaluated, and it is possible to visualize the utilization rate of renewable energy power and the gainings from transport and to present data useful in formulation of a power generation equipment plan and an operation plan. In addition, the nanogrid operation information indicating power and the vehicle operation information indicating a value other than power can be integrated and visualized to be presented to a user (for example, a self-governing community, a business operator, or the like that considers grid introduction), and hence the operation policy on the power or on the electric vehicle 3 can be determined in consideration of a plurality of values. It is also possible to propose a regional energy system that creates new values including commuter traffic in which people and freight are transported through mutual cooperation of the electric vehicle 3 and the nanogrid 1.

Further, the energy transport optimization support system 10 performs, in accordance with input information for switching at least one of variations in power supply and demand for power or variations in environment relating to transport, simulation in consideration of the at least one of the variations in power supply and demand for power or the variations in environment relating to transport. Accordingly, robustness against expected uncertainty can be evaluated and visualized, and data useful in formulation of a power generation equipment plan and an operation plan can be presented.

Further, the energy transport optimization support system 10 performs simulation in accordance with selected information on a priority service on which importance is placed by a user. Accordingly, effects of optimization of balance between power generation and transport can be visualized, and data useful in formulation of an operation policy corresponding to a purpose can be presented.

Further, the energy transport optimization support system 10 displays a position, a stored electricity amount, and the number of transported persons of the electric vehicle 3 and a configuration and a stored electricity amount of the nanogrid 1 on the maps 521, 921, and 1221 in a superimposed manner. Accordingly, relationships between the nanogrids 1 and the electric vehicles 3 can be displayed in an easy-to-understand manner.

Further, the energy transport optimization support system 10 generates, in accordance with a stored electricity amount and a position of the electric vehicle 3, data for instructing the electric vehicle 3 to distribute power to the nanogrid 1. Accordingly, it is possible to employ operation in which electricity and transport are associated with each other, such as to transport, together with power, people to a place in which power is supplied.

Further, the energy transport optimization support system 10 displays a screen including a power data display area for displaying a power generation amount and demand for power of the nanogrid 1, a power generation data display area for displaying power supplied to the nanogrid 1, and a transport data display area for displaying a transport count and a running distance of the electric vehicle 3. Accordingly, a stored electricity amount, a renewable energy usage rate, and an ID of the charged nanogrid for each electric vehicle 3 are visualized as a charging history, and an operation status of transport can be evaluated, thereby being able to present data useful in formulation of a power generation equipment plan of the nanogrid 1 for improving the renewable energy usage rate and reducing a carbon dioxide emission amount.

Further, the energy transport optimization support system 10 displays a screen including a power generation data display area for displaying power supplied to the nanogrid 1 and a transport data display area for displaying a transport count and a running distance of the electric vehicle 3, and the transport data display area further displays data on transport counts and running distances of an engine vehicle and an electric motor vehicle. Accordingly, it is possible to visualize a cumulative transport count and a total running distance of the electric vehicle 3 and the engine vehicle, evaluate the carbon dioxide reduction amount in provision of a transport service, and present data useful in establishment of transport service profitability and the optimum number of vehicles.

Further, the energy transport optimization support system 10 displays a screen including a power generation data display area for displaying power supplied to the nanogrid 1 and a disaster prevention data display area for displaying states of an important facility in normal time and at the time of a disaster. Accordingly, it is possible to visualize a time that satisfies the reference stored electricity amount of an important facility such as an evacuation center in normal time, a charging amount of the electric vehicle 3, and the stored electricity amount of the important facility, evaluate a period in which power can be supplied in a self-sustaining manner at the time of a disaster and an important facility having a power shortage, and present data useful for formulation of an operation policy at the time of a disaster.

Further, the energy transport optimization support system 10 displays transport data indicating an environmental value on a screen based on the nanogrid operation information and the operation information. Accordingly, it is possible to present data useful in formulation of an operation policy for improving the environmental value in transport.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

1. A support system for supporting management of a regional energy system, the support system comprising:
an arithmetic device configured to execute predetermined processing; and
a storage device coupled to the arithmetic device,
the support system is configured with a computer including the arithmetic device and the storage device,
the regional energy system including: nanogrid equipment including at least one of a power generation device or an electricity storage device; and a vehicle in which a storage battery is installed,
wherein the support system is configured to:
receive, by the arithmetic device, power supply-demand information on the nanogrid equipment and transport information relating to transport by the vehicle;
perform, by the arithmetic device, simulation through use of the power supply-demand information and the transport information to calculate nanogrid operation information indicating a power status of the nanogrid equipment during a predetermined period and vehicle operation information indicating a running status and charging and discharging statuses of the vehicle; and
generate, by the arithmetic device data for displaying both data organized in terms of power supply and demand for power in the nanogrid equipment and data in terms of transport by the vehicle on a single screen based on the nanogrid operation information and the vehicle operation information.

2. The support system according to claim 1, wherein the arithmetic device is configured to perform, in accordance with input information for switching at least one of variations in power supply and demand for power or variations in environment relating to transport, simulation in consideration of the at least one of the variations in power supply and demand for power or the variations in environment relating to transport.

3. The support system according to claim 1, wherein the arithmetic device is configured to perform simulation in accordance with selected information on a priority service on which importance is placed by a user.

4. The support system according to claim 1, wherein the arithmetic device is configured to generate data for displaying a position, a stored electricity amount, and the number of transported persons of the vehicle and a configuration and a stored electricity amount of the nanogrid equipment on a map in a superimposed manner.

5. The support system according to claim 1, wherein the arithmetic device is configured to generate, in accordance with a stored electricity amount and a position of the vehicle, data for instructing the vehicle to distribute power to the nanogrid equipment.

6. The support system according to claim 1, wherein the arithmetic device is configured to generate data for displaying a screen including a power data display area for displaying a power generation amount and demand for power of the nanogrid equipment, a power generation data display area for displaying power supplied to the nanogrid equipment, and a transport data display area for displaying a transport count and a running distance of the vehicle.

7. The support system according to claim 1,
wherein the arithmetic device is configured to generate data for displaying a screen including a power generation data display area for displaying power supplied to the nanogrid equipment and a transport data display area for displaying a transport count and a running distance of the vehicle, and
wherein the transport data display area is further configured to display data on transport counts and running distances of an engine vehicle and an electric motor vehicle.

8. The support system according to claim 1, wherein the arithmetic device is configured to generate data for displaying a screen including a power generation data display area for displaying power supplied to the nanogrid equipment and a disaster prevention data display area for displaying states of an important facility in normal time and at a time of a disaster, the important facility including a load that uses power.

9. A support method of supporting management of a regional energy system by a support system,
the support system including a computer including: an arithmetic device configured to execute predetermined processing; and a storage device coupled to the arithmetic device, the regional energy system including: nanogrid equipment including at least one of a power generation device or an electricity storage device; and a vehicle in which a storage battery is installed,
the support method comprising steps of:
receiving, by the arithmetic device, power supply-demand information on the nanogrid equipment and transport information relating to transport by the vehicle;
performing, by the arithmetic device, simulation through use of the power supply-demand information to calculate nanogrid operation information indicating a power status of the nanogrid equipment during a predetermined period;
performing, by the arithmetic device, simulation through use of the transport information to calculate operation information indicating a running status and charging and discharging statuses of the vehicle during the predetermined period; and
generating, by the arithmetic device data for displaying both data organized in terms of power supply and demand for power in the nanogrid equipment and data organized in terms of transport by the vehicle on a single screen based on the nanogrid operation information and the operation information.

10. A support system for supporting management of a regional energy system, the support system comprising a computer including: an arithmetic device configured to execute predetermined processing; and a storage device coupled to the arithmetic device,
the regional energy system including: nanogrid equipment including at least one of a power generation device or an electricity storage device; and a vehicle in which a storage battery is installed,
wherein the support system is configured to:
receive, by the arithmetic device, power supply-demand information on the nanogrid equipment and transport information relating to transport by the vehicle;
perform, by the arithmetic device, simulation through use of the power supply-demand information and the transport information to calculate nanogrid operation information indicating a power status of the nanogrid equipment during a predetermined period and vehicle operation information indicating a running status and charging and discharging statuses of the vehicle; and
generate, by the arithmetic device, based on the nanogrid operation information and the vehicle operation information, data for displaying transport data indicating an environmental value on a screen.

11. (canceled)
